(19) United States
(12) Patent Application Publication
(10) Pub. No.: US 2015/0215265 A1
(43) Pub. Date: Jul. 30, 2015

(54) METHOD AND APPARATUS FOR MANAGING INTERNET PROTOCOL (IP) AND MEDIA ACCESS CONTROL (MAC) TABLES OF TUNNEL END POINT (TEP) AND ADDRESS RESOLUTION PROTOCOL (ARP) TABLE OF SERVER CONNECTED TO TEP

(71) Applicant: Electronics and Telecommunications Research Institute, Daejeon (KR)

(72) Inventor: Chang Gyu LIM, Daejeon (KR)

(21) Appl. No.: 14/605,273

(22) Filed: Jan. 26, 2015

(30) Foreign Application Priority Data
Jan. 24, 2014 (KR) 10-2014-0008877

(51) Int. Cl. H04L 29/12; H04L 12/741; H04L 12/755; H04L 12/18

(52) U.S. Cl. CPC H04L 61/103; H04L 12/18; H04L 45/74; H04L 45/021

(57) ABSTRACT

A method and apparatus for efficiently managing and updating an Internet protocol (IP) table and a media access control (MAC) table of a tunnel end point (TEP) and an address resolution protocol (ARP) table of a server in which an ARP packet and a response ARP packet are transceived amongst TEPs connected via a network through a multicast absent an additional unicast tunnel and an overload of a Layer 3 (L3) network is significantly reduced is provided.

### CROSS-REFERENCE TO RELATED APPLICATION

This application claims the priority benefit of Korean Patent Application No. 10-2014-0008877, filed on Jan. 24, 2014, in the Korean Intellectual Property Office, the disclosure of which is incorporated herein by reference.

### BACKGROUND

1. Field of the Invention

Embodiments of the present invention relate to a method of managing an Internet protocol (IP) table and a media access control (MAC) table of a tunnel end point (TEP) connected via a network and an address resolution protocol (ARP) table of a server connected to the TEP, and more particularly, to a method of managing an IP table and an MAC table of a TEP and an ARP table of a server connected to the TEP by transceiving an ARP packet via a multicast.

2. Description of the Related Art

In an environment of a virtual extensible local area network (VxLAN), a Layer 2 (L2) network may be extended via a VxLAN network identifier (VNI).

A system based on the VxLAN network may include one or more VxLAN tunnel end points (VTEP). Each of the one or more VTEPs may include an Internet protocol (IP) table that registers and manages an IP address of the VTEPs for a plurality of VNIs and a media access control (MAC) table that registers and manages an MAC address of servers connected to the VTEPs.

When a request server connected to a VTEP intends to communicate with a target server connected to another VTEP, the request server needs to obtain an MAC address of the target server. The request server transmits an ARP packet to the target server to obtain the MAC address of the target server.

Accordingly, a large number of ARP packets is transmitted via a Layer 3 (L3) network because each server connected to the VTEP needs to obtain an MAC address of all the servers with which communication is to be performed. When the large number of ARP packets is transceived via the L3 network, an overload may occur in the L3 network. The overload in the L3 network may lead to a delay in updating of an ARP table of the servers, to and correspondingly, communication amongst the servers may also experience a delay.

Accordingly, there is a need for a method of efficiently managing an IP table and an MAC table of all VTEPs and ARP tables of all servers of the system based on the VxLAN network that reduces the overload in the L3 network.

The aforementioned description is provided to assist the reader in gaining a comprehensive understanding of the methods, apparatuses, and/or systems described herein, and may include content that does not form part of the related art. Also, descriptions of functions and constructions that are well known to one of ordinary skill in the art may be omitted for increased clarity and conciseness.

### SUMMARY

An aspect/embodiment of the present invention provides a method and apparatus for updating an Internet protocol (IP) table and a media access control (MAC) table of tunnel end points (TEP) by transceiving, through a multicast, an address resolution protocol (ARP) packet and a response ARP packet amongst the TEPs connected via a network.

Another aspect of the present invention also provides a method and apparatus for updating ARP tables of servers by transceiving, through a multicast, an ARP packet and a response ARP packet amongst the servers connected to TEPs connected via a network.

According to an aspect of the present invention, there is provided a method of managing an IP table and an MAC table conducted by a TEP connected to one or more TEPs via a network, the method including receiving a first packet from a server connected to the TEP, wherein the first packet is associated with communication between the server and at least one other server connected to one of the one or more TEPs, updating at least one of an IP table and an MAC table of the TEP based on the received first packet, generating a second packet adapted to be transmitted to one or more other TEPs from among the one or more TEPs based on a message type of the received first packet, and transmitting the generated second packet to the one or more other TEPs.

The transmitting of the second packet may include transmitting the second packet to the one or more other TEPs via a multicast tunnel.

The generating of the second packet may include setting a multicast address assigned to the server to be a destination IP address of the second packet, and generating the second packet including the first packet as a payload when the first packet is an ARP packet in a request type.

The generating of the second packet may include setting a multicast address assigned to the server to be a destination IP address of the generated second packet, generating a gratuitous ARP (GARP) packet based on the first packet when the first packet is a response ARP packet in a response type, and generating the second packet including the generated GARP packet as a payload.

The updating of the at least one of the IP table and the MAC table may include updating the at least one of the IP table and the MAC table by registering, in the at least one of the IP table and the MAC table, an MAC address of the server indicated by the first packet.

The server may be a request server.

The first packet transmitted by the request server may be an ARP packet in a request type to obtain an MAC address of a target server with which the request server desires to communicate.

The method of managing the IP table and the MAC table conducted by the TEP connected to the one or more TEPs via the network may further include receiving a third packet from a first TEP connected to the target server from among the one or more other TEPs.

The third packet may be generated based on a response ARP packet with respect to the second packet transmitted to the target server via the first TEP.

The third packet may be transmitted, from the first TEP, to one of more other TEPs connected to the first TEP via the network.

The method of managing the IP table and the MAC table conducted by the TEP connected to the one or more TEPs via the network may further include updating the at least one of the IP table and the MAC table based on the received third packet.

The receiving of the third packet may include receiving the third packet from the first TEP via a multicast tunnel.

The third packet may include the GARP packet generated based on the response ARP packet as a payload.

The updating of the at least one of the IP table and the MAC table may include updating the at least one of the IP table and the MAC table by registering at least one of the MAC address of the target server, an MAC address of the first TEP, and an IP address of the first TEP in the at least one of the IP table and the MAC table.

The server may be a target server.

The first packet transmitted by the target server is a response APR packet in a response type with respect to an ARP packet in a request type transmitted to the target server from a request server.

The request server may be a server that desires to communicate with the target server.

The ARP packet in the request type is transmitted to the target server from the request server to obtain an MAC address of the target server.

According to another aspect of the present invention, there is provided a method of managing an ARP table conducted by a server connected to a TEP, the method including transmitting a first packet to the TEP, wherein the first packet is an ARP packet in a request type or a response APR in a response type, and the first packet transmitted to the TEP is included in a second packet generated by the TEP to be transmitted to one or more other TEPs connected to the TEP via a network, receiving a third packet from the TEP, wherein the third packet is an ARP packet in a request type or a response APR packet in a response type, and transmitted to the TEP from the one or more other TEPs connected to the TEP via the network, and updating an ARP table of the server based on the received third packet.

The server may be a request server, and the first packet transmitted by the request server is the ARP packet in the request type to obtain an MAC address of a target server with which the request server desires to communicate.

The receiving of the third packet from the TEP may include receiving the third packet based on a response ARP packet in a response type of the target server with respect to the transmitted second packet.

The updating of the ARP table may include updating the ARP table by registering at least one of an MAC address of another server indicated by the third packet, an MAC address of the one or more other TEPs, and an IP address of the one or more other TEPs in the ARP table.

According to still another aspect of the present invention, there is provided a TEP connected to one or more TEPs via a network, the TEP including a packet reception processing unit to receive a first packet from a server connected to the TEP, a table manager to update at least one of an IP table and an MAC table based on the received first packet, and a packet transmission processing unit to generate a second packet based on a message type of the received first packet, and transmit the generated second packet to one or more other TEPs from among the one or more TEPs.

The TEP may further include an address manager.

The packet transmission processing unit may set a multicast address assigned to the server provided in the address manager to be a destination IP address of the second packet.

The server may be a request server.

The first packet transmitted by the request server may be an ARP packet in a request type to obtain an MAC address of a target server with which the request server desires to communicate.

The packet reception processing unit may receive a third packet from a first TEP connected to the target server from among the one or more other TEPs.

The third packet may be generated based on a response ARP packet in a response type with respect to the second packet transmitted to the target server via the first TEP.

The third packet may be transmitted, from the first TEP, to one or more other TEPs connected to the first TEP via the network.

The table manager may update the at least one of the IP table and the MAC table based on the received third packet.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system including tunnel end points (TEP) and servers according to an embodiment of the present invention;

FIG. 2 is a diagram illustrating packet transcription amongst TEPs according to an embodiment of the present invention;

FIG. 3 is a diagram illustrating a TEP according to an embodiment of the present invention;

FIG. 4 is a diagram illustrating a server according to an embodiment of the present invention;

FIG. 5 is a flowchart illustrating a method of managing at least one of an Internet protocol (IP) table and a media access control (MAC) table according to an embodiment of the present invention;

FIG. 6 is a flowchart illustrating a method of generating a second packet according to an embodiment of the present invention;

FIG. 7 is a flowchart illustrating a method of updating at least one of an IP table and an MAC table according to an embodiment of the present invention; and

FIG. 8 is a flowchart illustrating a method of managing an address resolution protocol (ARP) table according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

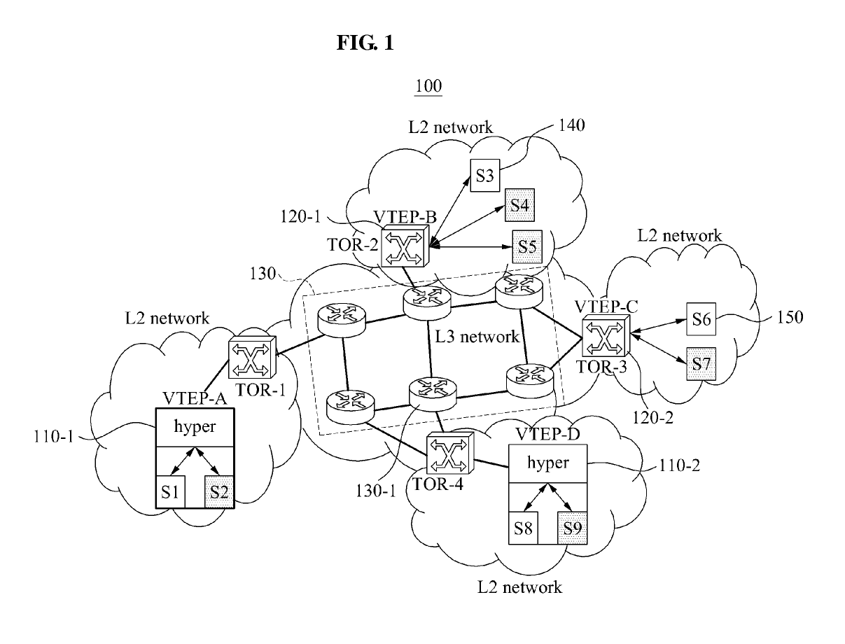

FIG. 1 is a diagram illustrating a system 100 including tunnel end points (TEP) and servers according to an embodiment of the present invention.

The system 100 includes one or more TEPs. Each of the one or more TEPs of the system 100 is connected to at least one segment via a network. For example, the at least one segment connected to the TEP may be a server.

Referring to FIG. 1, the system 100 is illustrated to include four TEPs. The TEPs included in the system 100 are connected to one another via the network. The network connecting the TEPs may be based on a virtual local area network (VLAN) or a virtual extensible local area network (VxLAN). For example, each of the TEPs included in the system 100 may be a virtual TEP (VTEP).

Servers connected to VTEPs, for example, VTEP-A, VTEP-B, VTEP-C, and VTEP-D, included in the system 100, respectively, have a VxLAN network identifier (VNI). For example, servers S1, S3, S6, and S8 from among servers S1 through S9 may have an identical VNI. Alternatively, remaining servers S2, S4, S5, S7, and S9 may have an identical VNI. The VNI of the servers S1, S3, S6, and S8 may differ from the VNI of the servers S2, S4, S5, S7, and S9.

Each of the VTEPs, for example, VTEP-A, VTEP-B, VTEP-C, and VTEP-D, is implemented in a Layer 2 (L2) network, and communicates with the at least one server via the L2 network.

Packet transception amongst the VTEPs is performed via a Layer 3 (L3). The packet transception amongst the VTEPs is performed by passing through one or more routers 130. A router 130-1 from among the one or more routers 130 may function as a rendezvous point (RP) 130-1 in packet transception via a multicast.

VTEP-A includes a hypervisor 110-1 to operate as a VTEP, and VTEP-D includes a hypervisor 110-2 to operate as a VTEP. Each of the hypervisors 110-1 and 110-2 may be a logical platform to execute at least one operating system (OS) in a host computer. For example, each of the hypervisors 110-1 and 110-2 may be a virtual machine monitor (VMM). The hypervisors 110-1 and 110-2 correspond to VTEP-A and VTEP-D, respectively.

VTEP-B includes a top of rack (TOR) switch 120-1 to operate as a VTEP, and VTEP-C includes a TOR switch 120-2 to operate as a VTEP. For example, the TOR switches 120-1 and 120-2 correspond to VTEP-B and VTEP-C, respectively.

Each of the VTEPs includes at least one of an Internet protocol (IP) table and a media access control (MAC) table. For example, in an IP table of the each of the VTEPs, IP addresses of other VTEPs connected to the each VTEP are registered. In an MAC table of the each of the VTEPs, MAC addresses of other VTEPs and/or MAC addresses of servers connected to the other VTEPs connected to the each VTEP are registered. In an IP table and an MAC table of the each of the VTEPs, MAC addresses and/or IP addresses of other VTEPs, and MAC addresses of servers connected to the other VTEPs are registered for a plurality of VNIs. For example, with respect to the servers S1, S3, S6, and S8 having the identical VNI, IP addresses of VTEP-A, VTEP-C and VTEP-D connected to the servers S1, S3, S6, and S8 may be registered in an IP table of VTEP-B, and MAC addresses of VTEP-A, VTEP-C and VTEP-D and/or MAC addresses of the servers S1, S3, S6, and S8 may be registered in an MAC table of VTEP-B.

Each of the servers S1, S3, S6, and S8 includes an address resolution protocol (ARP) table. The ARP table includes information associated with MAC addresses of other servers with which each server desires to communicate. For example, in the ARP table included in the each server, at least one of IP and/or MAC addresses of VTEPs not connected to the each server and MAC addresses of servers connected to the VTEPs may be registered.

Content of an ARP table of a server, content of an IP table of a TEP connected to the server and an MAC table of the TEP connected to the server may be used to obtain MAC addresses of other servers.

A request server from among the servers S1 through S9 communicates with a target server differing from the request server. For example, the request server may refer to a server that desires to communicate with the target server. An MAC address of the target server needs to be obtained to allow the request server to communicate with the target server.

The request server obtains an MAC address corresponding to an IP address of the target server using an ARP table. When the request server does not obtain the MAC address of the target server, the request server transmits an ARP packet to the target server to obtain the MAC address of the target server. The target server responds using a response ARP packet associated with the received ARP packet. The request server updates the ARP table of the request server by receiving the response ARP packet from the target server and obtaining the MAC address of the target server.

The ARP packet transmitted by the request server is transmitted to the target server by being transmitted to a VTEP connected to the target server via another VTEP connected to the request server. The response ARP packet transmitted by the target server is transmitted to the request server by being transmitted to a VTEP connected to the request server via another VTEP connected to the target server.

The aforementioned transception of the ARP packet and the response ARP packet amongst the VTEPs may be performed via a multicast tunnel. For example, the ARP packet may be transmitted to VTEPs connected to the target server, and also transmitted to VTEPs connected to other servers having a multicast address identical to the target server. The response ARP packet may be transmitted to VTEPs connected to the request server, and also transmitted to VTEPs connected to other servers having a multicast address identical to the request server.

The server S3 is a request server 140, and the server S6 is a target server 150 as shown in FIG. 1. A VNI and a multicast address of the request server 140 may be identical to a VNI and a multicast address of the target server 150.

An IP table and an MAC table of VTEPs and an ARP table of servers connected to the VTEPs may be updated by transmitting an ARP packet and a response ARP packet to a VTEP connected a request server, another VTEP connected to a target server, and VTEPs connected to the VTEP connected to the request server.

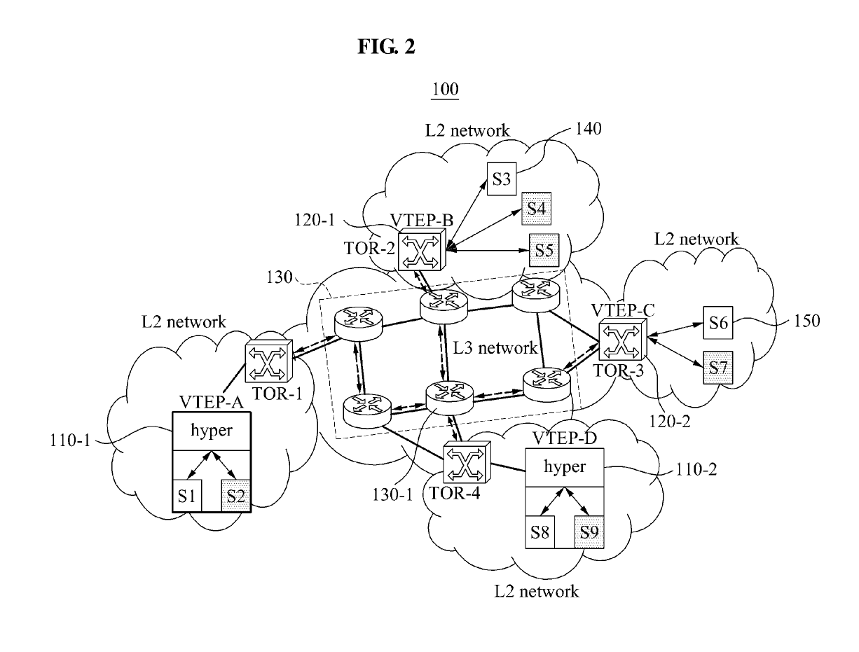

A method of managing an IP table, an MAC table, and an ARP table by transceiving an ARP packet and a response ARP packet amongst VTEPs and servers will be described with reference to FIGS. 2 through 8.

FIG. 2 is a diagram illustrating packet transception amongst TEPs according to an embodiment of the present invention.

FIG. 2 illustrates a method of transceiving an ARP packet and a response ARP packet amongst the VTEPs and the servers of the system 100 previously described with reference to FIG. 1.

A message type of an ARP packet generated by the request server 140 may differ from a message type of a response ARP packet generated by the target server 150. For example, the ARP packet generated by the request server 140 may be an ARP packet in a request type, and the response ARP packet generated by the target server 150 may be an ARP packet in a response type.

The ARP packet and the response ARP packet are transceived amongst VTEPs via a multicast tree as illustrated in FIG. 2.

For example, as previously described with reference to FIG. 1, the server S3 from among the servers S1, S3, S6, and S8 having the identical VNI is the request server 140, and the server S6 is the target server 150 with which the request server 140 intends to communicate. The request server 140 requests an MAC address of the target server 150 in order to transmit a packet to the target server 150. When the MAC address of the target server 150 is unobtainable through an ARP table of the request server 140, the request server 140 generates an ARP packet, and transmits the ARP packet to the VTEP 120-1. The VTEP 120-1 sets a multicast address assigned to the servers S1, S3, S6, and S8 as a destination IP address of a VXLAN header, and transmits the ARP packet to the VTEPs 110-1, 110-2, and 120-2 connected to the servers S1, S3, S6, and S8. Each of the VTEPs 110-1, 110-2, and 120-2 that receive the ARP packet from the VTEP 120-1 updates an IP table and/or an MAC table for each of the VTEPs 110-1, 110-2, and 120-2. The VTEPs 110-1, 110-2, and 120-2 that receive the ARP packet transmit the ARP packet to the servers S1, S6, and S8, and each of the servers S1, S6, and S8 that receive the ARP packet updates an ARP table for each of the servers S1, S6, and S8. The target server 150 from among the servers S1, S6, and S8 that receive the ARP packet generates a response ARP packet associated with the received ARP packet, and transmits the generated response ARP packet to the VTEP 120-2. The VTEP 120-2 that receive the response ARP packet sets the multicast address assigned to the servers S1, S3, S6, and S8 as the destination IP address of the VXLAN header, and transmits the response ARP packet to the VTEPs 110-1, 110-2, and 120-1 connected to the servers S1, S3, and S8. Each of the VTEPs 110-1, 110-2, and 120-1 that receive the response ARP packet from the VTEP 120-2 updates an IP table and/or an MAC table for each of the VTEPs 110-1, 110-2, and 120-1. The VTEPs 110-1, 110-2, and 120-1 that receive the response ARP packet transmit the response ARP packet to the servers S1, S3, and S8, and each of the servers S1, S3, and S8 that receive the response ARP packet updates an ARP table for each of the servers S1, S3, and S8. The request server 140 obtains the MAC address of the target server 150 using the updated ARP table.

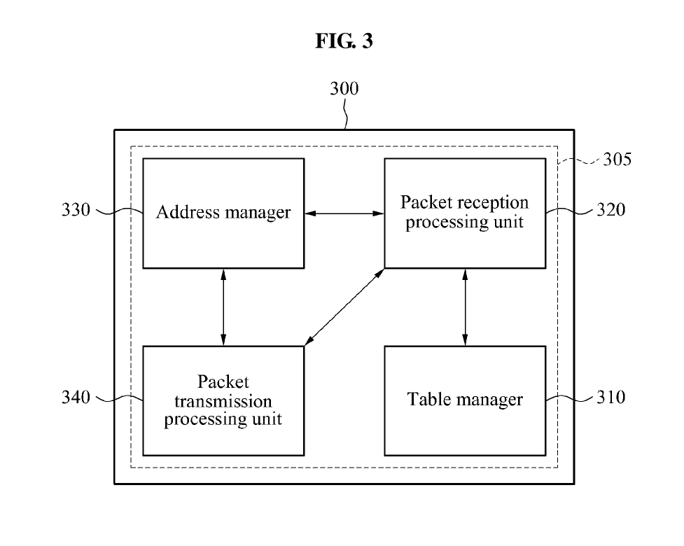

The method of managing the IP table, the MAC table, and the ARP table by transceiving the ARP packet and the response ARP packet amongst the VTEPs and the servers will be described with reference to FIGS. 3 through 8.

Since the technical features described with reference to FIG. 1 may be directly applicable here, a detailed description will be omitted for conciseness.

In the following description of example embodiments, unless otherwise indicated, the term “TEP” may refer to a “VTEP”. For example, the term “TEP” is interchangeably used with the term “VTEP”.

FIG. 3 is a diagram illustrating a TEP 300 according to an embodiment of the present invention.

FIG. 3 illustrates a structure of the (V)TEP 300 previously described with reference to FIGS. 1 and 2. The TEP 300 may be a TEP connected to at least one of servers S1 through S9. For example, the TEP 300 may correspond to a TEP connected to the request server 140, a TEP connected to the target server 150, or a TEP connected to a server aside from the request server 140 and the target server 150. In detail, a structure for each of the TEPs connected to the at least one of the servers S1 through S9 may be identical to the example illustrated in FIG. 3.

By way of example, each of the TEP 120-1, TEP 120-2, the TEP 110-1, and the TEP 110-2 may refer to an instance of the TEP 300, and indicate that the TEP 300 executes differing functions. Each constituent of the TEP 300 to be discussed later may correspond to each constituent of the TEP 120-1, TEP 120-2, the TEP 110-1, and the TEP 110-2.

The TEP 300 includes a segment manager 305. The TEP 300 is illustrated to include a single segment manager 305, however, the segment manager 305 may be provided for a plurality of VNIs assigned to the servers S1 through S9. For example, as previously described with reference to FIGS. 1 and 2, two segment managers 305 may be provided for a VNI of segments S1, S3, S6, and S8 and a VNI of segments S2, S4, S5, S7, and S9, respectively.

The segment manager 305 includes a table manager 310, a packet reception processing unit 320, an address manager 330, and a packet transmission processing unit 340. The packet transmission processing unit 340 generates a packet adapted to be transmitted to other VTEPs aside from the (V)TEP 300 based on a message type of an ARP packet and a response ARP packet received by the packet reception processing unit 320 from a server. An ARP packet received by the packet reception processing unit 320 from the request server 140 is a request type. A response ARP packet received by the packet reception processing unit 320 from the target server 150 is a response type.

Descriptions pertaining to an instance in which the TEP 300 corresponds to the TEP 120-1 connected to the request server 140 will be provided hereinafter.

A packet reception processing unit of the TEP 120-1 receives an ARP packet from the request server 140. The packet reception processing unit transmits an MAC address of the request server 140 included in the ARP packet to a table manager of the TEP 120-1. The table manager updates an MAC table of the TEP 120-1 by registering the transmitted MAC address.

A packet transmission processing unit of the TEP 120-1 generates an ARP packet adapted to be transmitted to the other TEPs, for example, VTEP-A, VTEP-C, and VTEP-D, connected to the TEP 120-1 based on the received ARP packet. The ARP packet generated by the packet transmission processing unit of the TEP 120-1 is transmitted to the other TEPs, for example, VTEP-A, VTEP-C, and VTEP-D. For example, the ARP packet generated by the packet transmission processing unit of the TEP 120-1 is flooded in the L2 network.

IP tables and MAC tables of the other TEPs, for example, VTEP-A, VTEP-C, and VTEP-D, and ARP tables of the servers S1, S6, and S8 connected to the other TEPs, for example, VTEP-A, VTEP-C, and VTEP-D, are updated by the transmitted packet.

The packet reception processing unit of the TEP 120-1 receives a response ARP packet generated by the TEP 120-2 connected to the target server 150 from among the other TEPs, for example, VTEP-A, VTEP-C, and VTEP-D, that receive the ARP packet transmitted by the packet transmission processing unit. The response ARP packet generated by the TEP 120-2 is generated based on the response ARP packet generated by the target server 150 as a response ARP packet adapted to be transmitted to the other TEPs, for example, VTEP-A, VTEP-B, and VTEP-D.

The table manager of the TEP 120-1 updates an IP table and/or an MAC table of the TEP 120-1 based on information associated with the target server 150 and the TEP 120-2 indicated by the response ARP packet received by the packet reception processing unit of the TEP 120-1.

The packet reception processing unit of the TEP 120-1 transmits the received response ARP packet to the request server 140, and the request server 140 updates an ARP table based on the information associated with the target server 150 and the TEP 120-2 indicated by the response ARP packet in the ARP table of the request server 140.

Descriptions pertaining to an instance in which the TEP 300 corresponds to the TEP 120-2 connected to the target server 150 will be provided hereinafter.

A packet reception processing unit of the TEP 120-2 receives, from the TEP 120-1 connected to the request server 140, an ARP packet generated by another server based on the ARP packet generated by the request server 140. A table manager of the TEP 120-2 updates an IP table and/or an MAC table of the TEP 120-2 based on information associated with the request server 140 and the TEP 120-1 indicated by the ARP packet received by the packet reception processing unit. The packet reception processing unit of the TEP 120-2 transmits the received ARP packet to the target server 150, and the target server 150 updates an ARP table based on the information associated with the request server 140 and the TEP 120-1 indicated by the ARP packet in the ARP table of the target server 150.

The target server 150 generates a response ARP packet associated with the received packet, and transmits the generated response ARP packet to the TEP 120-2.

A packet transmission processing unit of the TEP 120-2 generates a response ARP packet adapted to be transmitted to the other TEPs, for example, VTEP-A, VTEP-B, and VTEP-D, connected to the TEP 120-2 based on the received response ARP packet. The response ARP packet generated by the packet transmission processing unit is transmitted to the other TEPs, for example, VTEP-A, VTEP-B, and VTEP-D.

IP tables and MAC tables of the other TEPs, for example, VTEP-A, VTEP-B, and VTEP-D, and ARP tables of the servers S1, S3, and S8 connected to the other TEPs, for example, VTEP-A, VTEP-B, and VTEP-D, are updated by the transmitted response ARP packet.

The aforementioned ARP packet may be a request type, and the response ARP packet may be a response type.

Concisely, IP tables and MAC tables of all the TEPs and ARP tables of the servers of the system 100 are updated by transceiving the ARP packet and the response ARP packet between the request server 140 and the target server 150.

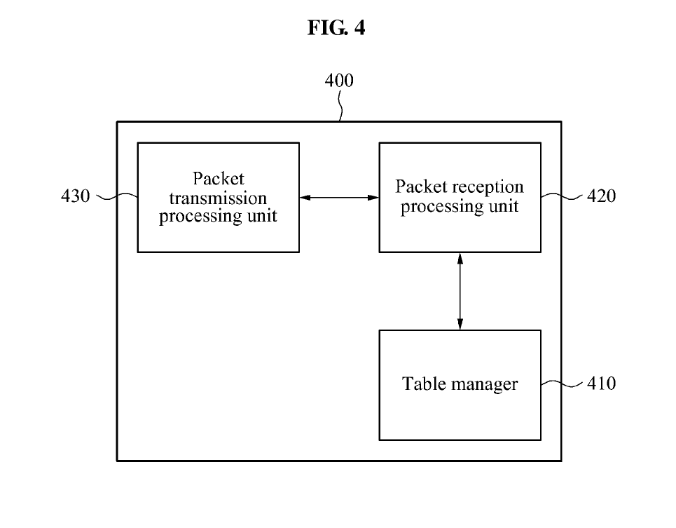

The method of managing the IP table, the MAC table, and the ARP table by transceiving the ARP packet and the response ARP packet amongst the VTEPs and the servers will be described with reference to FIGS. 4 through 8.

Since the technical features described with reference to FIGS. 1 and 2 may be directly applicable here, a detailed description will be omitted for conciseness.

FIG. 4 is a diagram illustrating a server 400 according to an embodiment of the present invention.

FIG. 4 illustrates a structure of the server 400 previously described with reference to FIGS. 1 through 3. The server 400 may be one of servers S1 through S9. For example, the server 400 may correspond to the request server 140, the target server 150, or a server aside from the request server 140 and the target server 150.

The server 400 includes a table manager 410, a packet reception processing unit 420, and a packet transmission processing unit 430.

The packet reception processing unit 420 receives an ARP packet in a request type or a response ARP packet in a response type from a TEP connected to the server 400.

The table manager 410 updates an ARP table based on the received ARP packet or the response ARP packet.

The packet transmission processing unit 430 transmits the ARP packet in the request type or the response ARP packet in the response type to the TEP connected to the server 400. For example, when the server 400 is the request server 140 and is unaware of an MAC address of the target server 150, the packet transmission processing unit 430 generates an ARP packet in a request type, and transmits the generated ARP packet to the TEP. Alternatively, when the server 400 is the target server 150 with respect to the ARP packet in the request type received by the packet reception processing unit 420, the packet transmission processing unit 430 generates a response ARP packet associated with the ARP packet in the request type received by the packet reception processing unit 420, and transmits the generated response ARP packet to the TEP.

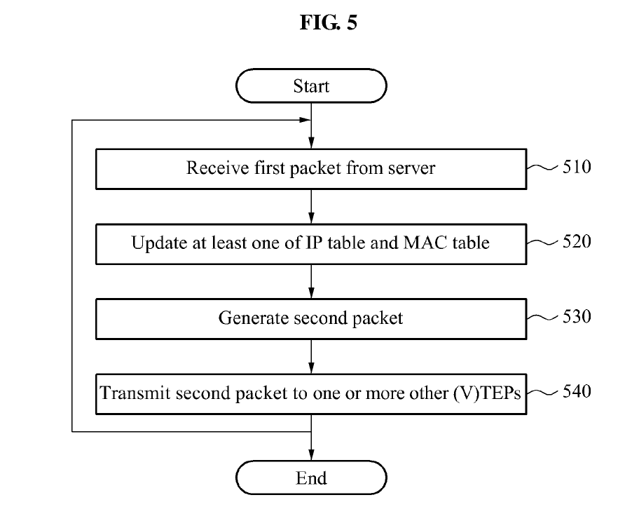

The method of managing the IP table, the MAC table, and the ARP table by transceiving the ARP packet and the response ARP packet amongst the VTEPs and the servers will be described with reference to FIGS. 5 through 8.

Since the technical features described with reference to FIGS. 1 through 3 may be directly applicable here, a detailed description will be omitted for conciseness.

FIG. 5 is a flowchart illustrating a method of managing at least one of an IP table and an MAC table according to an embodiment of the present invention.

FIG. 5 illustrates the method of managing the at least one of the IP table and the MAC table of the TEP 300 previously described with reference to FIG. 3. The TEP 300 is connected to one or more TEPs via a network as previously described with reference to FIGS. 1 and 2.

In operation 510, the packet reception processing unit 320 receives a first packet from a server connected to the TEP 300. The first packet may be a packet associated with communication between the server connected to the TEP 300 and at least one other server connected to another TEP. In one example, the server connected to the TEP 300 may be the request server 140. A first packet transmitted by the request server 140 may be an ARP packet to obtain an MAC address of the target server 150 with which the request server 140 intends to communicate. The ARP packet may be a request type.

In another example, the server connected to the TEP 300 may be the target server 150. A first packet transmitted by the target server 150 may be a response ARP packet in a response type associated with the ARP packet in the request type transmitted to the target server 150 from the request server 140. The ARP packet transmitted to the target server 150 from the request server 140 is transmitted to the target server 150 by being transmitted to the TEP 300 from the TEP connected to the request server 140.

In operation 520, the table manager 310 updates at least one of an IP table and an MAC table of the TEP 300 based on the received first packet. The table manager 310 updates the at least one of the IP table and the MAC table of the TEP 300 by registering an IP address and/or an MAC address of a server indicated by the received first packet. For example, when the server that transmits the first packet is the request server 140 or the target server 150, an IP address and/or an MAC address of the request server 140 or the target server 150 may be registered in the IP table and/or the MAC table of the TEP 300.

In operation 530, the packet transmission processing unit 340 generates a second packet adapted to be transmitted to one or more other TEPs aside from the TEP 300 from among the TEPs connected to the TEP 300 based on a message type of the received first packet. For example, the second packet may be an ARP packet or a response ARP packet adapted to be transmitted to the one or more other TEPs.

The packet transmission processing unit 340 identifies a message type of an ARP packet in a request type or a response ARP packet in a response type, and generates the second packet adapted to be transmitted to the one or more other TEPs. The second packet may be generated by changing the first packet or modifying VXLAN header information. For example, the first packet may be generated as the second packet adapted to be transmitted to the one or more other TEPs by setting a destination IP address or changing a format of a packet.

The second packet includes at least one an IP address of a server that transmits the first packet, an MAC address of the server, an IP address of the TEP 300, and an MAC address of the TEP 300.

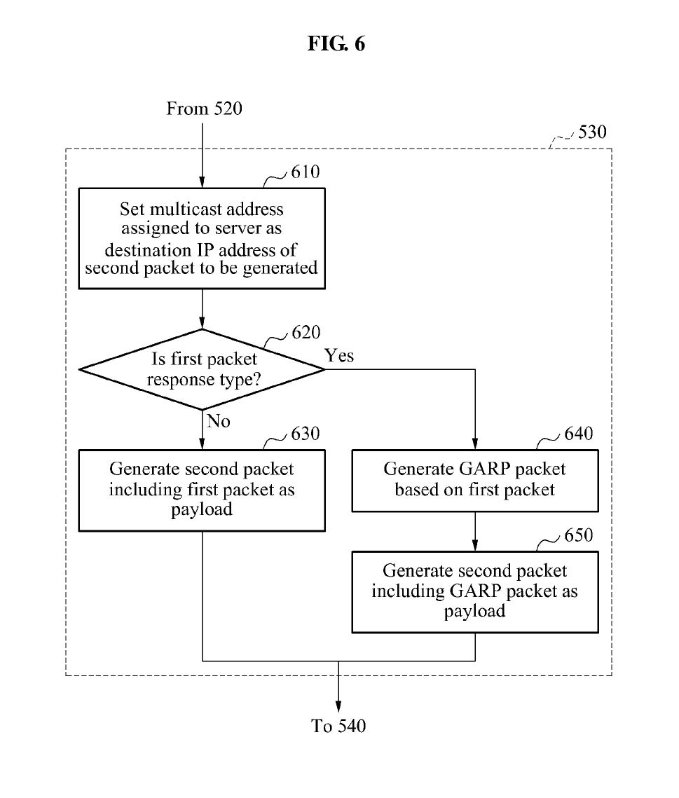

A method in which the packet transmission processing unit 340 generates the second packet will be described later with reference to FIG. 6.

In operation 540, the packet transmission processing unit 340 transmits the second packet generated in operation 530 to the one or more other TEPs. For example, the packet transmission processing unit 340 transmits the second packet to the one or more other TEPs via a multicast tunnel.

A destination IP address of the transmitted second packet may be a multicast address assigned to the server that generates the first packet. For example, the second packet is transmitted, via the multicast tunnel, to TEPs connected to other servers belonging to a multicast group identical to the server that generates the first packet via a multicast tunnel. Alternatively, the second packet is transmitted to TEPs connected to servers having a VNI identical to the server that generates the first packet.

An IP table and/or an MAC table of a TEP that receives the second packet and an ARP table of at least one server connected to the TEP that receives the second packet are updated based on information included in the second packet through the second packet being transmitted to one or more TEPs.

Operations 510 through 540 may be performed iteratively. For example, the updating of the table in operation 520 and the generating and transmitting of the second packet in operations 530 and 540 may be iteratively performed when the first packet is received from a server.

Since the technical features described with reference to FIGS. 1 through 4 may be directly applicable here, a detailed description will be omitted for conciseness.

FIG. 6 is a flowchart illustrating a method of generating a second packet according to an embodiment of the present invention.

In operation 530 previously described with reference to FIG. 5, the packet transmission processing unit 340 generates a second packet adapted to be transmitted to one or more other TEPs aside from the TEP 300 from among one or more TEPs connected to the TEP 300 based on a message type of a received first packet. Operation 520 may include operations 610 through 650.

In operation 610, the packet transmission processing unit 340 sets a multicast address assigned to a server that transmits a first packet provided in the address manager 330 as a destination IP address of a second packet to be generated. The multicast address assigned to the server may be a multicast address of a multicast group to which the server belongs. For example, the second packet may be transmitted to TEPs connected to servers belonging to the multicast group identical to the server that transmits the assigned first packet. In operation 620, the packet transmission processing unit 340 identifies a message type of the first packet received by the packet reception processing unit 320. The message type of the first packet may be a request type or a response type. For example, the first packet may be an ARP packet in a request type or a response ARP packet in a response type.

The packet transmission processing unit 340 generates the second packet adapted to be transmitted to the one or more other TEPs aside from the TEP 300 from among the TEPs connected to the TEP 300 based on the identified message type of the first packet.

An order of operations 610 and 620 may differ from the example illustrated in FIG. 6. For example, although not illustrated, the packet transmission processing unit 340 may identify the message type of the first packet, and set the destination IP address of the second packet to be generated.

In operation 630, when the first packet is the ARP packet in the request type, the packet transmission processing unit 340 generates a second packet including the first packet as a payload.

For example, a destination IP of a header of the second packet is set as the multicast address assigned to the server that transmits the first packet, and the first packet, for example, an ARP packet, is included in the second packet as the payload.

In operation 540, the generated second packet is transmitted to one or more TEPs. In operation 640, when the first packet is the response ARP packet in the response type, the packet transmission processing unit 340 generates a gratuitous ARP (GARP) packet based on the first packet. A request IP address of the generated GARP packet may be identical to a destination IP address of the generated GARP packet. A destination MAC address of the generated GARP packet may be a broadcast.

In operation 650, the packet transmission processing unit 340 generates the second packet including the generated GARP packet as a payload.

For example, the destination IP of the header of the second packet is set as the multicast address assigned to the server that transmits the first packet, and the first packet, for example, a response ARP packet, is included in the second packet as the payload subsequent to being changed to a GARP packet.

In operation 540, the generated second packet is transmitted to the one or more TEPs.

At least one server connected to the one or more TEPs receives the GARP packet through the second packet being transmitted to the one or more TEPs, and based on the received GARP packet, a table manager of the at least one server updates an ARP table. For example, ARP tables of servers aside from the request server 140 are updated by receiving the GARP.

Since the technical features described with reference to FIGS. 1 through 5 may be directly applicable here, a detailed description will be omitted for conciseness.

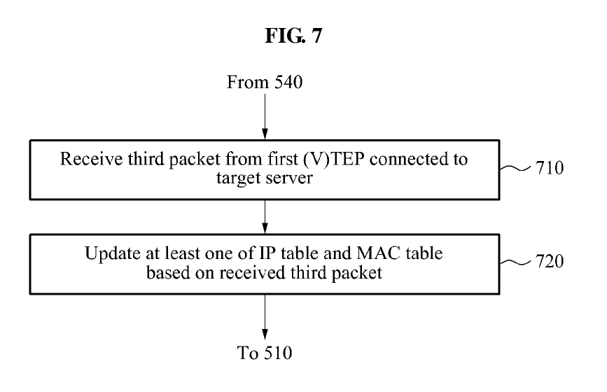

FIG. 7 is a flowchart illustrating a method of updating at least one of an IP table and an MAC table according to an embodiment of the present invention.

As previously described with reference to FIGS. 3 through 5, a server that transmits a first packet is the request server 140. For example, the TEP 300 is a TEP connected to the request server 140.

In operation 710, the packet reception processing unit 320 receives a third packet from a first TEP connected to the target server 150 from among one or more other TEPs to which a second packet is transmitted, subsequent to the second packet being transmitted to the one or more other TEPs in operation 540. The third packet is generated based on a response ARP packet with respect to the second packet transmitted to the target server 150 via the first TEP.

The third packet is transmitted, from the first TEP, to one or more other TEPs connected to the first TEP via a network.

The third packet may be a response ARP packet adapted to be transmitted to the one or more other TEPs. For example, the third packet is generated as a packet adapted to be transmitted to the one or more other TEPs by setting a destination IP address or changing a format of the packet. The third packet may correspond to the second packet generated in operation 650 previously described with reference to FIG. 6. For example, the third packet may include, as a payload, a GARP packet generated based on a response ARP packet transmitted from the target server 150.

The packet reception processing unit 320 receives the third packet from the first TEP via a multicast tunnel. The multicast tunnel used to receive the third packet may be identical to the multicast tunnel used to transmit the second packet in operation 540.

In operation 720, the table manager 310 updates at least one of an IP table and an MAC table based on the received third packet. For example, the table manager 310 updates the at least one of the IP table and the MAC table by registering, in the at least one of the IP table and the MAC table, at least one of an MAC address of the target server 150, an IP address of the target server 150, an IP address of the first TEP, an MAC address of the first TEP included in the third packet.

The third packet received in operation 710 is transmitted to the request server 140. The table manager 410 of the request server 140 updates an ARP table based on the MAC address of the target server 150 included in the third packet.

Since the technical features described with reference to FIGS. 1 through 6 may be directly applicable here, a detailed description will be omitted for conciseness.

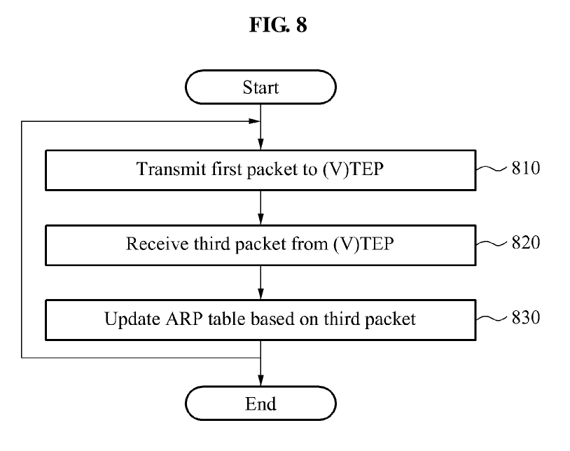

FIG. 8 is a flowchart illustrating a method of managing an ARP table according to an embodiment of the present invention.

FIG. 8 illustrates a method in which the server 400 connected to the TEP previously described with reference to FIGS. 2 through 7 manages an ARP table. The server 400 may correspond to the request server 140, the target server 150, or a server aside from the request server 140 and the target server 150.

In operation 810, the packet transmission processing unit 430 transmits a first packet to the TEP connected to the server 400. The first packet transmitted to the TEP may be an ARP packet in a request type or a response ARP packet in a response type. In one example, when the server 400 is the request server 140, the first packet may be the ARP packet in the request type to obtain an MAC address of the target server 150. In another example, when the server 400 is the target server 150, the first packet may be the response ARP packet in the response type.

The transmitted first packet is included in a second packet generated by the TEP connected to the server 400, and transmitted to one or more other TEPs connected to the TEP via a network. The second packet may be an ARP packet or a response ARP packet adapted to be transmitted to the one or more other TEPs.

In operation 820, the packet reception processing unit 420 receives a third packet from the TEP connected to the server 400. The third packet may be an ARP packet in a request type or a response ARP packet in a response type transmitted to the TEP connected to the server 400 from the one or more other TEPs connected the TEP connected to the server 400 via the network. In one example, when the server 400 is the request server 140, the packet reception processing unit 420 receives the third packet based on the response ARP packet of the target server 150 with respect to the second packet transmitted in operation 810. The third packet is transmitted, from a TEP connected to the target server 150, to the server 400 by being transmitted to the TEP connected to the server 400.

In another example, when the server 400 is the target server 150, the packet reception processing unit 420 receives the third packet based on the ARP packet in the request type transmitted by the request server 140. The reception of the third packet may be performed irrespective of performing operation 810. The packet transmission processing unit 430 transmits a response ARP packet associated with the received third packet to the TEP connected to the server 400. The transmission of the response ARP packet corresponds to the aforementioned operation 810.

In this sense, an order of operations 810 and 820 may differ from the example illustrated in FIG. 8. Alternatively, operations 810 and 820 may not be successively performed. For example, when the server 400 is a server aside from the request server 140 and the target server 150, operation 810 may not be performed.

In operation 830, the table manager 410 updates the ARP table of the server 400 based on the third packet received in operation 820. The table manager 410 updates the ARP table by registering at least one of an MAC address of another server indicated by the third packet, an MAC address of another TEP connected to the other server, and an IP address of the other TEP in the ARP table. The other server indicated by the third packet is a server that generates the ARP packet or the response ARP packet used to generate the third packet, and may correspond to the request server 140, the target server 150, or a server aside from the request server 140 or the target server 150.

Operations 810 through 830 may be performed iteratively. For example, when the server 400 is the request server 140, the reception of the third packet in operation 820 and the updating of the ARP table in operation 830 may be performed iteratively when the first packet, for example, an ARP packet in a request packet, is transmitted in operation 810.

The aforementioned transmission of the first packet and the reception of the third packet may be performed via a multicast tunnel amongst TEPs, and ARP tables of all servers connected to the TEPs may be updated.

According to an aspect of the present invention, there is provided a method and apparatus for managing an IP table and an MAC table of a TEP and an ARP table of a server by transceiving an ARP packet and a response ARP packet amongst TEPs connected via a network through a multicast absent an additional unicast tunnel.

According to an aspect of the present invention, there is provided a method and apparatus for managing an IP table and an MAC table of a TEP and an ARP table of a server that reduces an overload of an L3 by transceiving an ARP packet and a response ARP packet through an identical multicast tunnel.

Since the technical features described with reference to FIGS. 1 and 7 may be directly applicable here, a detailed description will be omitted for conciseness.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of managing an Internet protocol (IP) table and a media access control (MAC) table conducted by a tunnel end point (TEP) connected to one or more TEPs via a network, the method comprising:
receiving a first packet from a server connected to the TEP, wherein the first packet is associated with communication between the server and at least one other server connected to one of the one or more TEPs;
updating at least one of an IP table and an MAC table of the TEP based on the received first packet;
generating a second packet adapted to be transmitted to one or more other TEPs from among the one or more TEPs based on a message type of the received first packet; and
transmitting the generated second packet to the one or more other TEPs.

2. The method of claim 1, wherein the transmitting of the second packet comprises:
transmitting the second packet to the one or more other TEPs via a multicast tunnel.

3. The method of claim 1, wherein the generating of the second packet comprises:
setting a multicast address assigned to the server to be a destination IP address of the second packet; and
generating the second packet comprising the first packet as a payload when the first packet is an address resolution protocol (ARP) packet in a request type.

4. The method of claim 1, wherein the generating of the second packet comprises:
setting a multicast address assigned to the server to be a destination IP address of the generated second packet;
generating a gratuitous ARP (GARP) packet based on the first packet when the first packet is a response ARP packet in a response type; and
generating the second packet comprising the generated GARP packet as a payload.

5. The method of claim 1, wherein the updating of the at least one of the IP table and the MAC table comprises:
updating the at least one of the IP table and the MAC table by registering, in the at least one of the IP table and the MAC table, an MAC address of the server indicated by the first packet.

6. The method of claim 1, wherein the server is a request server,
and the first packet transmitted by the request server is an ARP packet in a request type to obtain an MAC address of a target server with which the request server desires to communicate.

7. The method of claim 6, further comprising:
receiving a third packet from a first TEP connected to the target server from among the one or more other TEPs, wherein the third packet is generated based on a response ARP packet with respect to the second packet transmitted to the target server via the first TEP, and the third packet is transmitted, from the first TEP, to one of more other TEPs connected to the first TEP via the network; and
updating the at least one of the IP table and the MAC table based on the received third packet.

8. The method of claim 7, wherein the receiving of the third packet comprises:
receiving the third packet from the first TEP via a multicast tunnel.

9. The method of claim 7, wherein the third packet comprises the GARP packet generated based on the response ARP packet as a payload.

10. The method of claim 7, wherein the updating of the at least one of the IP table and the MAC table comprises:
updating the at least one of the IP table and the MAC table by registering at least one of the MAC address of the target server, an MAC address of the first TEP, and an IP address of the first TEP in the at least one of the IP table and the MAC table.

11. The method of claim 1, wherein the server is a target server,
and the first packet transmitted by the target server is a response APR packet in a response type with respect to an ARP packet in a request type transmitted to the target server from a request server, and
the request server is a server that desires to communicate with the target server,
wherein the ARP packet in the request type is transmitted to the target server from the request server to obtain an MAC address of the target server.

12. A method of managing an address resolution protocol (ARP) table conducted by a server connected to a tunnel end point (TEP), the method comprising:
transmitting a first packet to the TEP, wherein the first packet is an ARP packet in a request type or a response APR in a response type, and the first packet transmitted to the TEP is comprised in a second packet generated by the TEP to be transmitted to one or more other TEPs connected to the TEP via a network;
receiving a third packet from the TEP, wherein the third packet is an ARP packet in a request type or a response APR packet in a response type, and transmitted to the TEP from the one or more other TEPs connected to the TEP via the network; and
updating an ARP table of the server based on the received third packet.

13. The method of claim 12, wherein the server is a request server,
and the first packet transmitted by the request server is the ARP packet in the request type to obtain a media access control (MAC) address of a target server with which the request server desires to communicate, and
the receiving of the third packet from the TEP comprises:
receiving the third packet based on a response ARP packet in a response type of the target server with respect to the transmitted second packet.

14. The method of claim 12, wherein the updating of the ARP table comprises:
updating the ARP table by registering at least one of an MAC address of another server indicated by the third packet, an MAC address of the one or more other TEPs, and an Internet protocol (IP) address of the one or more other TEPs in the ARP table.

15. A tunnel end point (TEP) connected to one or more TEPs via a network, the TEP comprising:
a packet reception processing unit to receive a first packet from a server connected to the TEP;
a table manager to update at least one of an Internet protocol (IP) table and a media access control (MAC) table based on the received first packet; and
a packet transmission processing unit to generate a second packet based on a message type of the received first packet, and transmit the generated second packet to one or more other TEPs from among the one or more TEPs.

16. The TEP of claim 15, further comprising an address manager,
wherein the packet transmission processing unit sets a multicast address assigned to the server provided in the address manager to be a destination IP address of the second packet.

17. The TEP of claim 15, wherein the server is a request server,
wherein the first packet transmitted by the request server is an ARP packet in a request type to obtain an MAC address of a target server with which the request server desires to communicate.

18. The TEP of claim 17, wherein the packet reception processing unit receives a third packet from a first TEP connected to the target server from among the one or more other TEPs,
wherein the third packet is generated based on a response ARP packet in a response type with respect to the second packet transmitted to the target server via the first TEP, and the third packet is transmitted, from the first TEP, to one or more other TEPs connected to the first TEP via the network, and
the table manager updates the at least one of the IP table and the MAC table based on the received third packet.
